(19) United States
(12) Patent Application Publication
(10) Pub. No.: US 2021/0095506 A1
(43) Pub. Date: Apr. 1, 2021

(54) HINGE DEVICE FOR ROTATING DOOR

(71) Applicant: PARTSTEC CONSTRUCTION CO., LTD, Gumi-si (KR)

(72) Inventors: Kil Seok Jeong, Gumi-si (KR); In Ho Cho, Chilgok-gun (KR); Jae Yeong Jeong, Gumi-si (KR)

(21) Appl. No.: 16/676,492

(22) Filed: Nov. 7, 2019

(30) Foreign Application Priority Data
Sep. 30, 2019 (KR) 10-2019-0121092

(51) Int. Cl. E05D 7/00; F25D 23/02; E05F 3/20

(52) U.S. Cl. CPC E05D 7/0009; F25D 23/028; E05Y 2900/31; F25D 2323/024; E05F 3/20

(57) ABSTRACT

The present invention relates to a hinge device for a rotating door, and more particularly, to a hinge device for a rotating door, which is mounted on the rotating door so that the door can be opened and closed while rotating in various ways. The hinge device for the rotating door of the present invention rotates by an external force and then rotated in a free stop manner at a certain section, and automatically rotates in a reverse direction at a section where the hinge device reversely rotates after free stop rotation.

### CROSS REFERENCE TO RELATED APPLICATIONS

The present application claims the benefit of Korean Patent Application No. 10-2019-0121092 filed on Sep. 30, 2019, the contents of which are incorporated herein by reference in their entirety.

### BACKGROUND OF THE INVENTION

### 1. Field of the Invention

The present invention relates to a hinge device for a rotating door, and more particularly, to a hinge device for a rotating door, which is mounted on the rotating door to allow the rotating door to be opened and closed while rotating in various ways.

### 2. Description of the Prior Art

A configuration in which a door is hinged to a specific body object to open or close an inside of the specific body object is generally known in the art.

For example, a refrigerator includes a body for storing foods and a door for opening or closing the body.

When the door of the refrigerator is opened by a great amount of external force, the door may collide with other objects so that the door may be damaged.

In addition, when the door of the refrigerator is closed by a great amount of external force, the body of the refrigerator may be subject to great impact so that a problem may occur because bowls and the like stored inside the refrigerator may be subject to the great impact.

In order to solve the above problem, conventionally, damping force is generated when the door of the refrigerator is opened or closed such that the door can be opened or closed slowly.

However, according to the conventional door of the refrigerator, the same damping force is applied when the door of the refrigerator is opened and closed, thereby causing a problem in which the door of the refrigerator door is opened too slowly when the damping force is large and shock is applied to body of the refrigerator when the damping force is small because the door of the refrigerator is closed at the speed the same as the speed generated when the door of the refrigerator is opened.

In addition, when a large or heavy object or a plurality of objects are put into or removed from the refrigerator, it is necessary to open the door of the refrigerator for a long period of time.

According to the conventional refrigerator, when a plurality of objects are put into or removed from the refrigerator, it is necessary for a user to put or remove the objects into or from the refrigerator by holding the door of the refrigerator such that the door is not closed because the door is automatically closed.

### PRIOR TECHNICAL DOCUMENTS

### Patent Documents

Unexamined Patent Publication No. 10-2006-0119459

Unexamined Patent Publication No. 10-2006-0099355

### SUMMARY OF THE INVENTION

The present invention has been made in an effort to solve the above-mentioned problems, and provides a hinge device for a rotating door, in which a door of a refrigerator can be conveniently opened and closed by allowing the door to rotate at different speeds when the door is opened or closed with respect to a body object (refrigerator, etc.), and the door, which is opened by rotating with respect to the body object, can be maintained in an opened state so that a user can conveniently put or remove things without interfering with the door when the things are put into or removed from an inside of the body object.

In order to accomplish the above object, a hinge device for a rotating door according to the present invention includes: a hollow housing provided therein with a support end having a hollow shape, in which a first inner chamber and a second inner chamber are formed at one side and an opposite side of the support end in communication with each other, respectively, and the first inner chamber is filled with oil; a shaft disposed in the first inner chamber and rotatably mounted inside the housing, in which one end of the shaft is exposed to an outside through one end of the housing, an opposite end of the shaft is disposed in the first inner chamber, and an outer circumferential surface of the shaft is spaced apart from the first inner chamber such that oil is filled therebetween; a damper unit installed in the first inner chamber to adjust an amount of flow of the oil filled in the first inner chamber during relative rotation of the housing and the shaft; a clutch member disposed between the opposite end of the shaft and the support end; a clutch ball mounted to one end of the clutch member to connect the clutch member to one of the support end and the shaft; a first support member having one end fixedly coupled to the clutch member and an opposite end disposed in the second inner chamber, in which a first coupling protrusion protrudes from the opposite end of the first support member; a second support member mounted to the opposite end of the housing and having a second coupling protrusion protruding toward an inside of the housing; and a torsion spring installed in the second inner chamber and having one end coupled to the first coupling protrusion and an opposite end coupled to the second coupling protrusion, wherein one end of the clutch member has a plate shape and is formed with a through hole into which the clutch ball is inserted to be movable in a longitudinal direction of the housing, a first seating groove is formed in the opposite end of the shaft to face the through hole such that the clutch ball inserted into the through hole is seated in the first seating groove, a second seating groove is formed at the support end to face the through hole such that the clutch ball inserted into the through hole is seated in the second seating groove, the shaft and the clutch member are connected to each other when the clutch ball is inserted into both the through hole and the first seating groove so that a rotational force of the shaft is transferred to the clutch member through the clutch ball when the shaft rotates, thereby rotating the clutch member together with the shaft, and the clutch member and the support end are connected to each other when the clutch ball is inserted into both the through hole and the second seating groove so that only the shaft independently rotates without rotation of the clutch ball and the clutch member when the shaft rotates.

The hinge device of the rotating door may include: a compression section, in which the clutch member rotates together with the shaft from an initial stop position to a predetermined first angle to compress the torsion spring when the shaft rotates forward by an external force; a free stop section in which the shaft rotates freely without compression or decompression of the torsion spring when the shaft rotates forward or backward in a state of exceeding the predetermined first angle; and a recovery section in which the shaft automatically rotates in a reverse direction by an elastic restoring force of the torsion spring to return to the initial stop position when the shaft rotates reversely below the predetermined first angle in the free stop section.

The second seating groove may be formed at a position corresponding to the predetermined first angle, the clutch ball may be inserted into the first seating groove and the through hole in the compression section and the recovery section so that the shaft, the clutch ball, and the clutch member rotate together, and the clutch ball may be inserted into the through hole and the second seating groove in the free stop section so that the shaft rotates independently from the clutch ball and the clutch member.

Each of a depth of the first seating groove and a depth of the second seating groove may be smaller than a radius of the clutch ball, so that a center point of the clutch ball may be disposed in the through hole in a state where the clutch ball is inserted into the first seating groove and the through hole, and the center point of the clutch ball may be disposed in the through hole in a state where the clutch ball is inserted into the second seating groove and the through hole.

In a state where the clutch ball is inserted into the first seating groove and the through hole, when the shaft rotates forward beyond the predetermined first angle, the first seating groove, the through hole, and the second seating groove may communicate with each other, and the clutch ball is pushed and moved by the rotation of the shaft so that the clutch ball comes out of the first seating groove and is inserted into the through hole and the second seating groove, and in a state where the clutch ball is inserted into the second seating groove and the through hole, when the shaft reversely rotates beyond the predetermined first angle, the first seating groove, the through hole, and the second seating groove communicate with each other, and the clutch ball may be pushed by the rotation of the clutch member caused by the elastic restoring force of the torsion spring so that the clutch ball may come out of the first seating groove and may be inserted into the through hole and the second seating groove.

A reverse rotational force caused by the elastic restoring force of the torsion spring may be applied to the shaft in the initial stop position.

The first seating grooves may be formed at intervals of 120 degrees, the clutch ball includes three clutch balls, the second seating grooves may be formed at intervals of 120 degrees, and the predetermined first angle may be less than 90 degrees at the initial stop position.

The housing may include: a first housing formed therein with the first inner chamber where the shaft is disposed, and provided at an opposite end thereof with the support end; and a second housing having one end coupled to the opposite end of the first housing and an opposite end on which the second support member is mounted, and formed therein with the second inner chamber where the torsion spring is disposed, and the opposite end of the clutch member may be fixedly coupled to the first support member through the support end.

The hinge device may further include a bearing surrounding the first support member, wherein one end of the bearing may be disposed between an inner peripheral surface of the second housing and the first support member so that the bearing may be rotatable and linear movement of the bearing may be prevented.

The hinge device may further include: a height adjusting nut screwed to one end of the housing; a height adjusting ring having one end exposed to an outside of one end of the height adjusting nut and one end of the housing, and an opposite end inserted between the height adjusting nut and the housing; and a snap ring configured to couple the height adjusting nut and the height adjusting ring to move the height adjusting nut and the height adjusting ring together in a longitudinal direction of the housing, wherein, when the height adjusting nut rotates relative to the housing, the height adjusting ring coupled to the height adjusting nut through the snap ring may move in the longitudinal direction of the housing to adjust a distance with respect to one end of the housing.

The damper unit may include: a blocking member having one end fixedly coupled to an inner peripheral surface of the first inner chamber and an opposite end making contact with an outer circumferential surface of the shaft; and a blade disposed between the shaft and the inner peripheral surface of the first inner chamber, wherein, when the shaft rotates, the blocking member may be fixed together with the housing and the blade may move together with the shaft while making contact with the inner peripheral surface of the first inner chamber, and the blade may change an amount of movement of the oil filled in the first inner chamber.

A first fluid path may be concavely formed at the inner peripheral surface of the first inner chamber in a circumferential direction of the housing, the blade may be disposed in a longitudinal direction of the shaft, when the shaft rotates, the blade may move through a portion where the first fluid path is absent and a portion where the first fluid path is present in contact with the inner peripheral surface of the first inner chamber, the oil may move through the first fluid path when the blade is disposed in the portion where the first fluid path is present, and the shaft may rotate more slowly when the blade is disposed in the portion where the first fluid path is absent than the blade is disposed in the portion where the first fluid path is present.

A third seating groove where the blade is seated may be formed on the outer circumferential surface of the shaft, the blade may be spaced apart from the third seating groove and the oil may move therebetween when the shaft rotates forward, and the blade may come in close contact with the third seating groove to block movement of the oil between the blade and the third seating groove when the shaft reversely rotates.

The third seating groove may include: a third-first seating groove having an arc shape; and a third-second seating groove formed by chamfering the shaft from the third-first seating groove in the circumferential direction of the shaft such that the third-second seating groove has a depth greater than a depth of the third-first seating groove, and the blade may be provided with a seating protrusion seated in the third-first seating groove, the seating protrusion may be smaller than the third-first seating groove and movably disposed in the third-first seating groove, when the shaft rotates forward, the seating protrusion may be pushed toward the third-second seating groove by the oil and may allow the third-first seating groove to communicate with the third-second seating groove so that the blade may be spaced apart from the third seating groove and the oil may move therebetween, and when the shaft reversely rotates, the seating protrusion may be pushed opposite to the third-second seating groove by the oil and may come in close contact with the third-first seating groove to prevent the oil from moving between the blade and the third seating groove.

The shaft may be formed at a center thereof with a bolt insertion hole, an oil adjusting bolt may be installed in a bolt insertion hole, a bypass passage may be formed in the shaft to allow the bolt insertion hole to communicate with the outer circumferential surface of the shaft, and a size of communication between the bypass passage and the bolt insertion hole may be variable by the oil adjusting bolt so that an amount of movement of the oil through the bypass passage may be controlled.

The hinge device for the rotating door according to the present invention described above has the following advantages.

The door of the refrigerator door can be conveniently opened and closed by allowing the door to rotate at different speeds when the door rotates to be opened or closed with respect to the body object (refrigerator, etc.).

In addition, the door, which is opened by rotating with respect to the body object (refrigerator, etc.), can be maintained in an opened state so that a user can conveniently put or remove things without interfering with the door when the things are put into or removed from an inside of the body object.

In particular, according to the present invention, a free stop scheme is adopted in a section exceeding a first angle such that rotation does not occur when there is no external force, and the door is automatically rotated in a section below the first angle, so that the door can be automatically rotated and conveniently closed.

### BRIEF DESCRIPTION OF THE DRAWINGS

The above and other objects, features, and advantages of the present invention will be more apparent from the following detailed description taken in conjunction with the accompanying drawings, in which:

FIG. 1 is a perspective view showing a configuration in which a hinge device for a rotating door according to an embodiment of the present invention is installed on a refrigerator.

FIG. 2 is a perspective view showing a hinge device for a rotating door according to an embodiment of the present invention.

FIG. 3 is an exploded perspective view of a hinge device for a rotating door in one direction according to an embodiment of the present invention.

FIG. 4 is an exploded perspective view of a hinge device for a rotating door in the other direction according to an embodiment of the present invention.

FIG. 5 is a perspective view showing a coupling state of a clutch member of a shaft of a hinge device for a rotating door according to an embodiment of the present invention.

FIG. 6 is a sectional view taken along line A-A of FIG. 2.

FIG. 7 is a view for explaining an operation of a hinge device for a rotating door at each angle upon rotation according to an embodiment of the present invention.

FIG. 8 is a cross-sectional view for explaining a process of forward rotation of a shaft of a hinge device for a rotating door according to an embodiment of the present invention.

FIG. 9 is a sectional view showing an operation of a height adjusting nut and a height adjusting ring according to an embodiment of the present invention.

FIG. 10 is a sectional view taken along line C-C of FIG. 2.

FIG. 11 is a sectional view showing a state of a damper unit in a process of forward rotation of a shaft of a hinge device for a rotating door shown in FIG. 10 according to an embodiment of the present invention.

FIG. 12 is a sectional view showing a state of a damper unit in a process of reverse rotation of a shaft shown in FIG. 11.

### DETAILED DESCRIPTION OF THE EXEMPLARY EMBODIMENTS

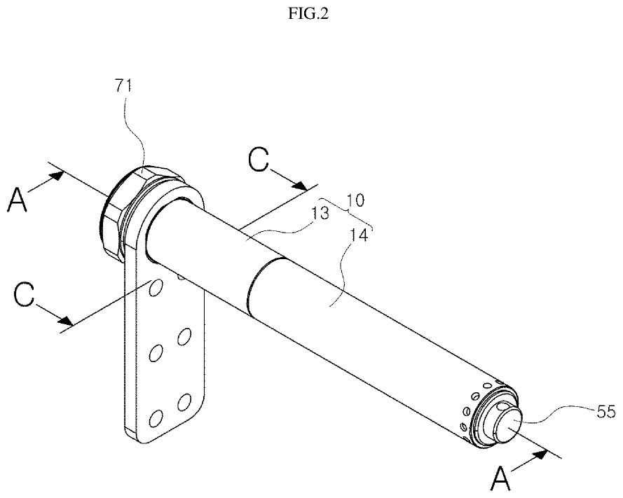

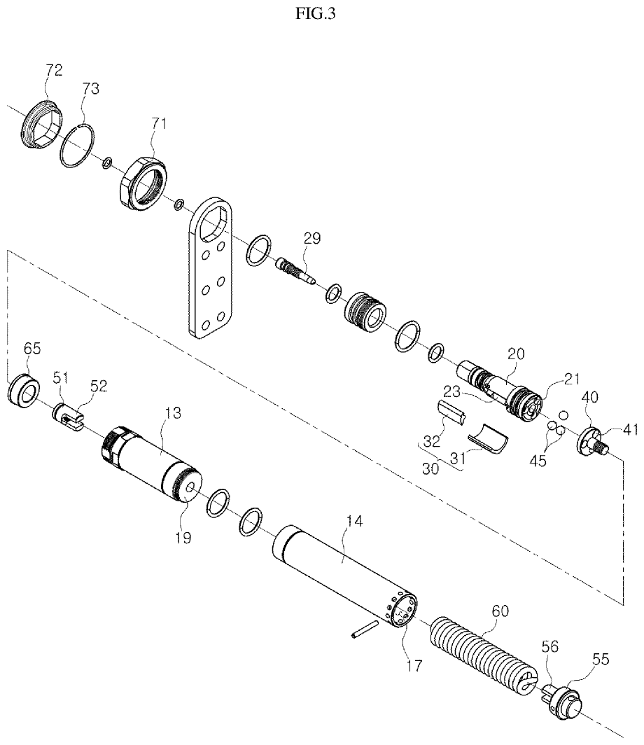

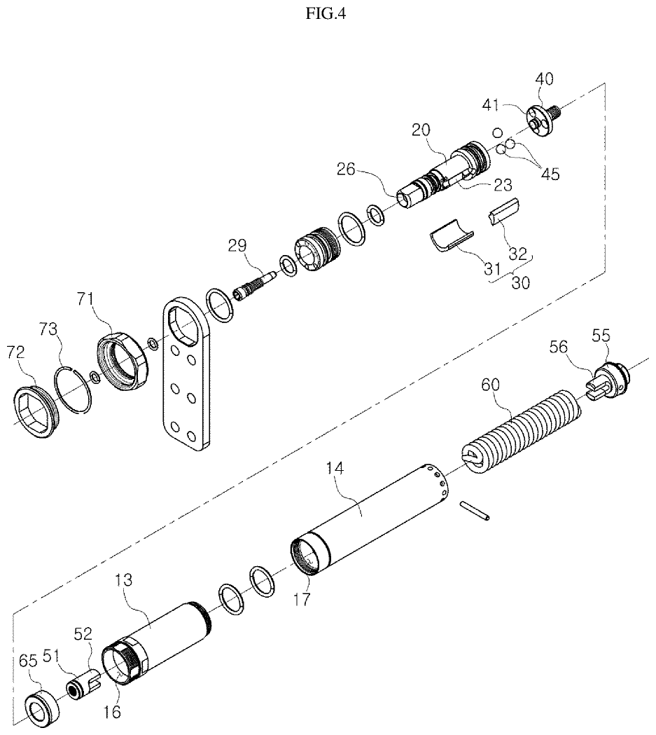

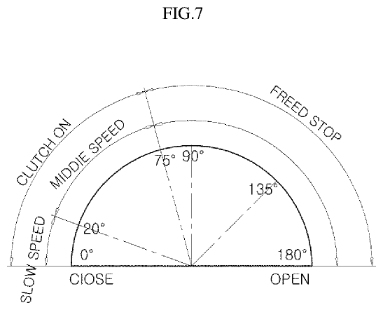

As shown in FIGS. 2 to 6, the hinge device for a rotating door of the present invention may include a housing 10, a shaft 20, a damper unit 30, a clutch member 40, a clutch ball 45, a first support member 51, a second support member 55, and a torsion spring 60.

In the present invention, one of the housing 10 and the shaft 20 may rotate relative to the other according to the mounting position thereof.

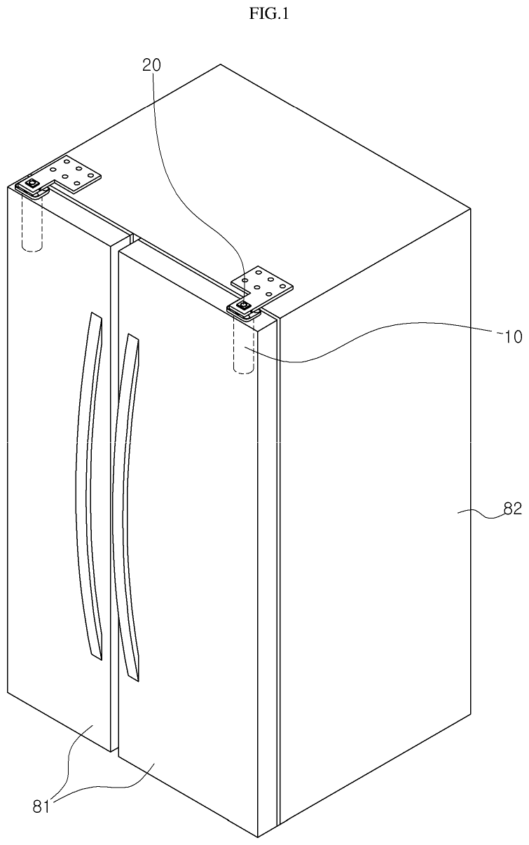

As shown in FIG. 1, the housing 10 may be fixedly mounted on an upper portion or a lower portion of a rotating door 81, and the shaft 20 is connected to a body object 82 (refrigerator, etc.) to which the door 81 is hinged so that the housing 10 rotates with respect to the shaft 20 when the door 81 rotates.

In the present embodiment, for the sake of convenience of explanation, the shaft 20 will be described on the premise that shaft 20 rotates relative to the housing 10.

Alternatively, the shaft 20 may be fixed and the housing 10 may be installed to rotate relative to the shaft 20, but the operation process and the technical configuration and features of the present invention are the same.

The housing 10 may have a hollow pillar shape, and a hollow support end 19 may be provided in the housing 10.

A first inner chamber 16 and a second inner chamber 17 may be formed on one side and the other side of the support end 19, respectively, and may communicate with each other through the hollow support end 19.

As will be described later, the first inner chamber 16 may be filled with oil.

The first inner chamber 16 may be formed between one end of the housing 10 and the support end 19, and the second inner chamber 17 may be disposed between the support end 19 and the other end of the housing 10.

In the present embodiment, the housing 10 may be formed by coupling a first housing 13 and a second housing 14 to each other.

The first inner chamber 16 and the support end 19 may be formed in the first housing 13, and the second inner chamber 17 may be formed in the second housing 14.

The shaft 20 may be disposed in the first inner chamber 16 of the first housing 13.

One end of the second housing 14 may be coupled to the other end of the first housing 13, the second support member 55 may be mounted to the other end of the second housing 14, and a torsion spring 60 may be disposed in the second inner chamber 17.

The support end 19 may be formed with a second seating groove 11 in which the clutch ball 45 is selectively seated.

In the drawing of the present embodiment, the second seating groove 11 may be formed in the direction from the support end 19 to the first inner chamber 16.

The shaft 20 may be disposed in the first inner chamber 16 and rotatably mounted to the housing 10.

The shaft 20 may be disposed in the first inner chamber 16 and rotatably mounted in the housing 10, in detail, in the first housing 13.

One end of the shaft 20 may be exposed to the outside through one end of the housing 10, and the other end may be disposed inside the first inner chamber 16.

The shaft 20 may have an outer circumferential surface spaced apart from an inner peripheral surface of the first inner chamber 16 so that oil may be filled therebetween.

A first seating groove 21 may be formed on the outer circumferential surface of the other end of the shaft 20.

The clutch ball 45 may be selectively seated in the first seating groove 21.

In the drawing of the present embodiment, the other end of the shaft 20 is disposed in the first inner chamber 16, but may be disposed in the second inner chamber 17 in some cases.

The damper unit 30 may be mounted in the first inner chamber 16 to adjust the amount of movement of oil filled in the first inner chamber 16 when the housing 10 and the shaft 20 rotate relative to each other.

More specifically, since the amount of movement of oil is changed by the damper unit 30 while the housing 10 and the shaft 20 move relative to each other, the relative rotational speed between the housing 10 and the shaft 20 may be changed according to the rotation section and/or the direction of rotation.

The damper unit 30 may generate a damping force during the rotation of the shaft 20 or the housing 10 to reduce the rotational torque of the shaft 20 or the housing 10.

In particular, the damper unit 30 may be disposed in the first inner chamber 16 to generate different damping forces for damping the rotational torque of the shaft 20 or the housing 10 in accordance with the rotational direction when the shaft 20 or the housing 10 rotates.

That is, the damper unit 30 may generate different damping forces according to the rotational direction of the shaft 20 or the housing 10, so that the rotational torque generated when the shaft 20 or the housing 10 rotates may be dampened with different intensity according to the rotational direction.

A conventional damper unit 30 generates the same damping force regardless of the rotational direction of the rotating body.

However, according to the present invention, the damper unit 30 may generate different damping forces according to the rotational direction of the shaft 20 or the housing 10, and thus the rotational speed of the shaft 20 or the housing may vary depending on the rotational direction when the shaft 20 or the housing 10 rotates.

According to the present embodiment, since the shaft 20 rotates, the rotational speed of the shaft 20 may vary by the damper unit 30 during the rotation of the shaft 20.

A detailed description for the structure of the damper unit 30 will be described below.

The clutch member 40 may be disposed between the other end of the shaft 20 and the support end 19.

The clutch ball 45 may be mounted to one end of the clutch member 40 to connect the clutch member 40 to one of the support end 19 and the shaft 20.

One end of the clutch member 40 may be formed in a plate shape, and may be formed with a through hole 41 into which the clutch ball 45 may be inserted to be movable in the longitudinal direction of the housing 10.

The through hole 41 may communicate with the first seating groove 21 or the second seating groove 11 as the shaft 20 rotates.

The clutch ball 45 may have a spherical shape and may be inserted into the through hole 41.

The first seating groove 21, in which the clutch ball 45 inserted into the through hole 41 while facing the through hole 41 is seated, may be formed at the other end of the shaft 20 and the second seating groove 11, in which the clutch ball 45 inserted into the through hole 41 while facing the through hole 41 is seated, may be formed at the support end 19.

The clutch ball 45 inserted into the through hole 41 may be disposed in the through hole 41, and may be selectively inserted into the first seating groove 21 or the second seating groove 11 according to the rotational angle of the shaft 20.

The shaft 20 and the clutch member 40 may be connected by the clutch ball 45 in a state where the clutch ball 45 is inserted into both the first seating groove 21 and the through hole 41, so that the rotational force of the shaft generated when the shaft 20 rotates may be transferred to the clutch member 40 through the clutch ball 45. Thus, the clutch member 40 may rotate together with the shaft 20.

In addition, in a state where the clutch ball 45 is inserted into both the through hole 41 and the second seating groove 11, the support end 19 and the clutch member 40 may be connected to each other by the clutch ball 45 so that only the shaft 20 may rotate independently from the clutch ball 45 and the clutch member 40 when the shaft 20 rotates.

According to the present embodiment, the first seating grooves 21 may be formed at intervals of 120 degrees, the clutch ball 45 may include three clutch balls, and the second seating grooves 11 may be formed at intervals of 120 degrees.

Unlike the present embodiment, the number and angle of the first seating groove 21, the clutch ball 45, and the second seating groove 11 may be adjusted.

One end of the first support member 51 may be fixedly coupled to the clutch member 40, the other end thereof may be disposed in the second inner chamber 17, and a first coupling protrusion 52 may protrude from the other end thereof.

The other end of the clutch member 40 may be fixedly coupled to the first support member 51 by passing through the support end 19.

A bearing 65 surrounding the first support member 51 may be mounted on an outer peripheral surface of the first support member 51.

One end of the bearing 65 may be disposed between an inner peripheral surface of one end of the second housing 14 and the first support member such that the bearing 65 may be rotatable and the linear movement of the bearing may be prevented.

The second support member 55 has a second coupling protrusion 56 protruding toward an inside of the housing 10.

The torsion spring 60 may be disposed in the second inner chamber 17 and may have one end coupled to the first coupling protrusion 52, and the other end coupled to the second coupling protrusion 56.

The torsion spring 60 may apply a force to rotate the clutch member 40 in the reverse rotational direction.

The torsion spring 60 may be placed in a compressed state to some extent even in the initial stop position where the shaft 20 is not rotated, so the reverse rotational power may be applied to the shaft by the elastic restoring force of the torsion spring 60.

Therefore, even when no external force is applied, the reverse rotational force may act on the shaft 20 so that the door may come in close contact with the body object.

The hinge device for a rotating door of the present invention may operate in a compression section, a free stop section, and a recovery section.

The compression section may be a section for compressing the torsion spring 60, in which the clutch member 40 may rotate together with the shaft 20 from the initial stop position to the predetermined first angle when the shaft 20 rotates forward by the external force, thereby compressing the torsion spring 60.

The first angle may be formed at an angle smaller than 90 degrees from the initial stop position.

For example, in the drawings of the present embodiment, the first angle is set as 75 degrees, and the compression section is set as a forward rotation section from the initial stop position, that is, from 0 to 75 degrees, but the present invention is not limited thereto.

In the compression section, the clutch ball 45 may be inserted into both the through hole 41 and the first seating groove 21 so that the clutch ball 45 may connect the shaft 20 with the clutch member 40 when the shaft 20 rotates. Thus, the shaft 20, the clutch ball 45 and the clutch member 40 may rotate together so that the rotational force of the shaft 20 may be transferred to the clutch member 40 and the torsion spring 60 may be compressed by the rotation of the clutch member 40.

The free stop section may be a section in which the shaft 20 may rotate freely without the force of the torsion spring 60. When the shaft 20 rotates in the forward or reverse direction beyond the first angle, the shaft 20 may freely rotate without compression or decompression of the torsion spring 60.

In the drawing of the present embodiment, the free stop section is illustrated as a range from a point exceeding the first angle, that is, from a point exceeding 75 degrees to 180 degrees.

In the free stop section, the clutch ball 45 may be inserted into both the through hole 41 and the second seating groove 11 without being seated in the first seating groove 21, so that the shaft 20 may rotate independently from the clutch ball 45 and the clutch member 40 when the shaft 20 rotates.

The recovery section may be a section in which the rotated shaft 20 rotates in the reverse direction to return back to the initial stop position. When the shaft 20 reversely rotates from the free stop section to the section located below the first angle, the shaft 20 may automatically rotate in the reverse direction by the elastic restoring force of the torsion spring 60 so that the shaft 20 may return to the initial stop position.

In the drawing of the present embodiment, the recovery section is illustrate as a reverse rotation section having a range from the first angle, that is, from 75 degrees to 0 degree.

In order to allow the clutch ball 45 to be selectively and smoothly inserted into the first seating groove 21 and the second seating groove 11 when the shaft 20 rotates, each of a depth of the first seating groove 21 and a depth of the second seating groove 11 may be smaller than a radius of the clutch ball 45.

In addition, in a state where the clutch ball 45 is inserted into the first seating groove 21 and the through hole 41, a center point of the clutch ball 45 may be disposed in the through hole 41. Further, in a state where the clutch ball 45 is inserted into the second seating groove 11 and the through hole 41, a center point of the clutch ball 45 may be disposed in the through hole 41.

Thus, as shown in FIG. 8, when the shaft 20 rotates forward in a state where the clutch ball 45 is inserted into the through hole 41 of the clutch member 40 and the first seating groove 21 of the shaft 20, since the center point of the clutch ball 45 is disposed in the through hole 41, the clutch ball 45 may be pushed by the shaft 20 tend to move in a direction opposite to the first seating groove 21. However, since through hole 41 is blocked by the support end 19, the shaft 20 and the clutch member 40 may rotate together in a state where the clutch ball 45 is disposed in the first seating groove 21 and the through hole 41.

When the shaft 20 and the clutch member 40 that rotate forward together reach the first angle, the first seating groove 21, the through hole 41, and the second seating groove 11 may communicate with each other.

Then, the clutch ball 45 may move while being pushed toward the second seating groove 11 by the rotating shaft 20, so that the clutch ball 45 may come out of the first seating groove 21 and may be inserted into the through hole 41 and the second seating groove 11.

As described above, when the clutch ball 45 comes out of the first seating groove 21, the rotational force of the shaft 20 may not be transferred to the clutch member 40.

In addition, in a state where the clutch ball 45 is inserted into the second seating groove 11 and the through hole 41, when the shaft 20 reversely rotates beyond the first angle, the first seating groove 21, the through hole 41, and the second seating groove 11 may communicate with each other, and the clutch ball 45 may come out of the first seating groove 21 while being pushed by the rotation of the clutch member 40 caused by the elastic restoring force of the torsion spring 60 and may be inserted into the through hole 41 and the second seating groove 11.

As shown in FIG. 8, when the shaft 20 rotates forward by the external force, the shaft 20 may rotate while compressing the torsion spring 60 from the initial stop position to the first angle, which may be a preset angle. When the shaft 20 rotates beyond the first angle, the shaft 20 may freely rotate without compressing the torsion spring 60.

In addition, when the shaft 20 rotates forward beyond the first angle and then rotates in the reverse direction by the external force, the shaft 20 may freely rotate up to the first angle without the elastic restoring force of the torsion spring 60. When the shaft 20 reaches the first angle, the shaft 20 may automatically rotate in the reverse direction by the elastic restoring force of the compressed torsion spring 60.

That is, the shaft 20 may rotate while compressing the torsion spring 60 or the shaft 20 may rotate by the elastic restoring force of the torsion spring 60 from the initial stop position to the first angle. In addition, when the shaft 20 rotates beyond the first angle, the shaft 20 may freely rotate in the forward and reverse directions without the action of the force by the torsion spring 60.

The torsion spring 60 may be compressed by the rotation of the first support member 51 coupled to the clutch member 40, and the first support member 51 and the clutch member 40 may be rotated when the torsion spring 60 is decompressed.

Therefore, when the shaft 20 rotates with respect to the housing 10, if the clutch ball 45 connects the shaft 20 to the clutch member 40, the rotational force of the shaft 20 may be transferred to the clutch member, thereby elastically deforming the torsion spring 60 while compressing the torsion spring 60.

In addition, when the clutch ball 45 is separated from the shaft 20 and connects the clutch member 40 to the support end 19, the shaft 20 may rotate independently from the clutch member 40.

In more detail, in the initial stop position of the shaft 20, the clutch ball 45 may be inserted into the first seating groove 21 and the through hole 41. In this state, when the shaft 20 rotates forward by the external force, the shaft 20 and the clutch member 40 may rotate together with the clutch ball 45 up to the predetermined first angle, thereby compressing the torsion spring 60.

Then, when the shaft 20 rotates beyond the first angle, the clutch ball 45 may come out of the first seating groove 21 by the rotation of the shaft 20 and may be inserted into the through hole 41 and the second seating groove 11, so that only the shaft 20 may freely rotate without compressing the torsion spring 60 and without rotation of the clutch member 40 and the clutch ball 45.

In addition, in a state where the shaft 20 rotates forward beyond the first angle, when the shaft 20 rotates in the reverse direction by the external force, the shaft 20 may freely rotate to the first angle without the elastic restoring force of the torsion spring 60.

Then, when the shaft 20 rotates beyond the first angle, the clutch ball 45 may come out of the second seating groove 11 by the rotational force of the clutch member 40 caused by the elastic restoring force of the torsion spring 60 and may be inserted into the through hole 41 and the first seating groove 21. Thus, the clutch member 40, the clutch ball 45, and the shaft 20 may automatically rotate in the reverse direction by the elastic restoring force of the torsion spring 60.

In addition, in order to limit the rotational angle of the shaft 20, an elongate rotary groove may be formed at an outer surface of the shaft 20 in the circumferential direction.

Further, a stopper having one end inserted into the rotary groove may be installed in the housing 10.

Due to the rotary groove and the stopper, when the shaft 20 rotates, the shaft 20 may be caught by the stopper inserted into the rotary groove so that the rotational angle of the shaft 20 may be limited.

Meanwhile, the damper unit 30 may include a blocking member 31 and a blade 32.

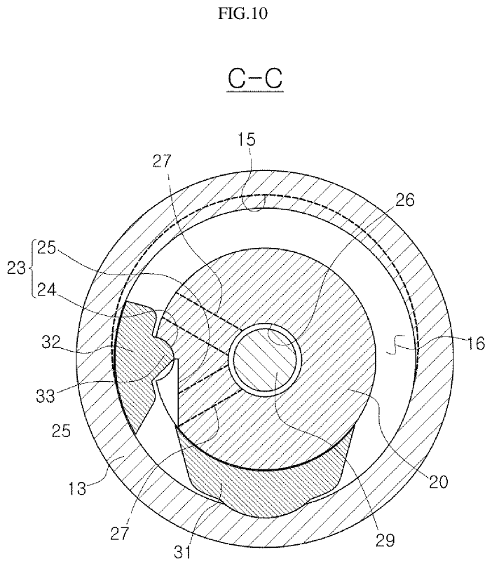

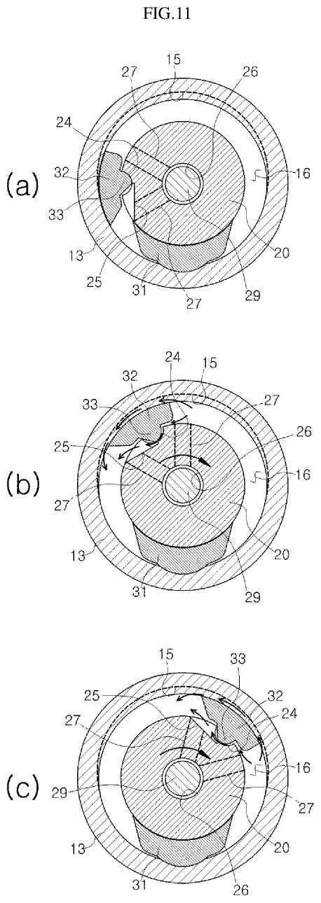

As shown in FIG. 10, one end of the blocking member 31 may be fixedly coupled to the inner peripheral surface of the first inner chamber 16, and the other end of the blocking member 31 may come in contact with the outer circumferential surface of the shaft 20, thereby preventing the oil filled in the first inner chamber 16 from moving across the blocking member 31.

Therefore, when the shaft 20 rotates, the blocking member 31 may be fixed together with the housing 10, so that the oil filled in the first inner chamber 16 and moved by the shaft 20 may be blocked by the blocking member 31, thereby generating hydraulic pressure.

The blade 32 may be disposed between the shaft 20 and the inner peripheral surface of the first inner chamber 16 and may vary the amount of movement of the oil filled in the first inner chamber 16 when the housing 10 and the shaft 20 rotate relative to each other.

When the shaft 20 rotates, the blade 32 may move together with the shaft 20 while making contact with the inner peripheral surface of the first inner chamber 16.

A third seating groove 23 in which the blade 32 is seated may be formed in the outer peripheral surface of the shaft 20.

As shown in FIG. 11, when the shaft 20 rotates forward, the blade 32 may be spaced apart from the third seating groove 23 so that the oil may flow therebetween.

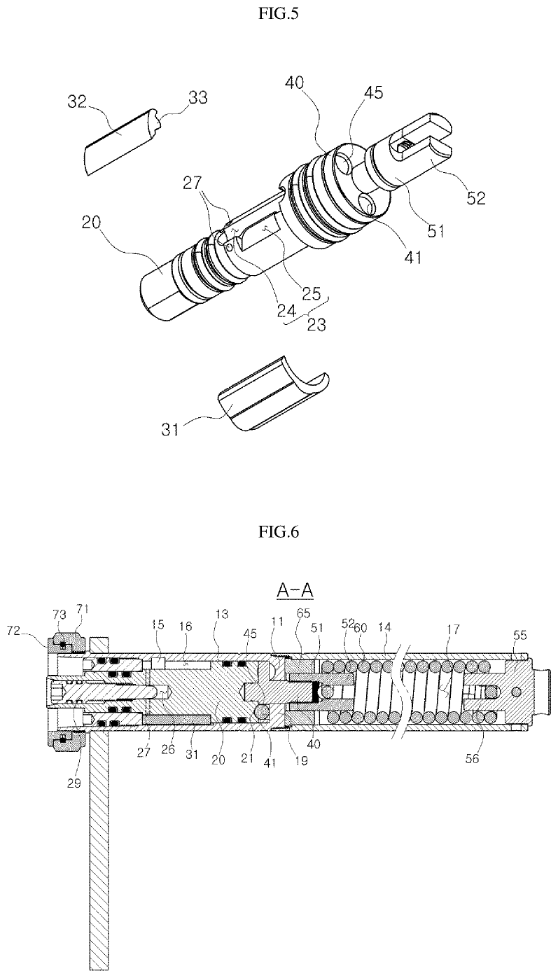

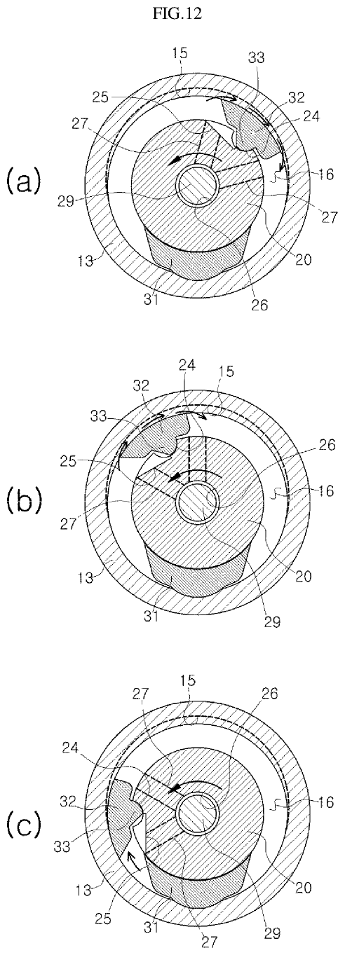

In addition, as shown in FIG. 12, when the shaft 20 rotates in the reverse direction, the blade 32 may come in close contact with the third seating groove 23, thereby blocking the oil flowing between the blade 32 and the third seating groove 23. As shown in FIGS. 5, 11, and 12, the third seating groove 23 may include a third-first seating groove 24 and a third-second seating groove 25.

The third-first seating groove 24 may be an arc-shaped groove, and may be concaved on the outer peripheral surface of the shaft 20 in the longitudinal direction of the shaft 20.

The third-second seating groove 25 formed by chamfering the shaft 20 from the third-first seating groove 24 in the circumferential direction of the shaft 20 such that the third-second seating groove 25 has a depth greater than a depth of the third-first seating groove 24

The size of the third-second seating groove 25 may be smaller than the size of the third-first seating groove 24.

In addition, the blade 32 may be provided with a seating protrusion 33 seated in the third-first seating groove 24.

The seating protrusion 33 may be smaller than the third-first seating groove 24 and may be movably disposed within the third-first seating groove 24.

As shown in FIG. 11, when the shaft 20 rotates forward, the seating protrusion 33 may be pushed toward the third-second seating groove 25 by the oil so that the third-first seating groove 24 may communicate with the third-second seating groove 25. Thus, the blade 32 may be spaced apart from the third seating groove 23 so that the oil may flow therebetween.

Further, as shown in FIG. 12, when the shaft 20 rotates in the reverse direction, the seating projection 33 may be pushed opposite to the third-second seating groove by the oil. Thus, the seating projection 33 may come into close contact with the third-first seating groove 24 thereby blocking the oil flowing between the blade 32 and the third seating groove 23.

Due to the blade 32 and the third seating groove 23, a difference in damping force may occur during the forward and reverse rotations of the shaft 20.

In addition, a first fluid path 15 may be formed in an inner peripheral surface of the first inner chamber 16 along the circumferential direction of the housing 10.

When the shaft 20 rotates, the blade 32 may move in contact with the inner peripheral surface of the first inner chamber 16 through a portion in which the first fluid path 15 is absent and a portion in which the first fluid path 15 is present.

When the blade 32 is disposed in the portion in which the first fluid path 15 is present, the oil may move opposite to the blade 32 through the first fluid path 15.

Therefore, when the shaft 20 rotates, if the blade 32 is disposed in the portion in which the first fluid path 15 is absent, the oil may rarely flow so that the shaft 20 may rotate somewhat slowly. When the blade 32 is disposed in the portion where the first fluid path 15 is present, the oil may flow through the first fluid path 15 so that the shaft 20 may rotate faster.

In addition, a bolt insertion hole 26 may be formed at the center of the shaft 20, and an oil adjusting bolt 29 may be installed in the bolt insertion hole 26.

The shaft 20 may be formed with a bypass passage 27 that allows the bolt insertion hole 26 to communicate with the outer circumferential surface of the shaft 20, and the communication size between the bypass passage 27 and the bolt insertion hole 26 may vary by the oil adjusting bolt 29 so that the amount of movement of the oil through the bypass passage 27 may be adjusted.

That is, the oil filled in the first inner chamber 16 may move in the opposite direction through the bypass passage 27 and the bolt insertion hole 26 when the housing 10 and the shaft 20 rotate relative to each other, thereby generating the damping force.

The present invention may further include a height adjusting nut 71, a height adjusting ring 72 and a snap ring 73.

The height adjusting nut 71 may be screwed to the outer peripheral surface of one end of the first housing 13.

One end of the height adjusting ring 72 may be exposed to the outside of one end of the height adjusting nut 71 and one end of the housing 10, and the other end thereof may be inserted between the height adjusting nut 71 and the housing 10.

The snap ring 73 may be disposed between the height adjusting nut 71 and the height adjusting ring 72 to couple the height adjusting nut 71 and the height adjusting ring 72 such that the height adjusting nut 71 and the height adjusting ring 72 can move in the longitudinal direction of the housing 10 together.

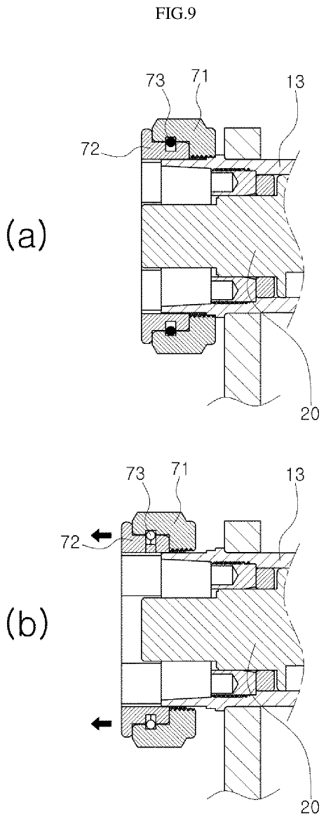

As shown in FIG. 9, since the height adjusting nut 71 is screwed to the housing 10 when the height adjusting nut 71 rotates with respect to the housing 10, the height adjusting nut 71 may move in the longitudinal direction of the housing 10.

In this case, the height adjusting ring 72 coupled to the height adjusting nut 71 through the snap ring 73 may move in the longitudinal direction of the housing 10 to adjust the distance with respect to one end of the housing 10.

Thus, when the housing 10 is vertically arranged and mounted in the door of the refrigerator, the height adjusting ring 72 may move in the longitudinal direction of the housing 10, so that the distance between the housing 10 and the body object, that is, the refrigerator body may be adjusted. Thus, the overall height of the hinge device may be adjusted.

Hereinafter, an operation process of the present invention having the above-described configuration will be described.

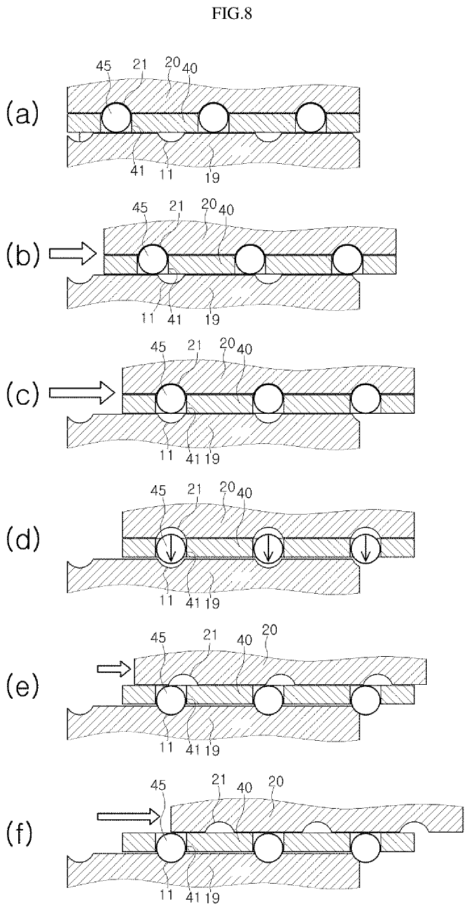

FIG. 7 is a view for explaining an operation of a hinge device for a rotating door at each angle upon rotation according to an embodiment of the present invention.

As shown in FIG. 7, according to the present embodiment, there are provided a compression section which ranges from 0 to 75 degrees and in which the shaft 20 rotates forward to compress the torsion spring 60 by the external force, a free stop section which exceeds 75 degrees and in which the shaft 20 freely rotates, and a recovery section which ranges from 75 degrees to 0 in the clockwise direction and in which the shaft 20 automatically rotates in a reverse direction by an elastic restoring force of the torsion spring 60.

In addition, when the blade 32 comes in contact with the inner peripheral surface of the housing 10 having no first fluid path 15, the shaft 20 may rotate more slowly.

According to the present embodiment, the shaft 20 may rotate forward by the external force within the first angle, that is, less than 75 degrees, and may automatically rotate in the reverse direction by the elastic restoring force of the torsion spring 60 when the external force is removed. In the section that exceeds the first angle, the shaft may rotate forward through the free stop scheme where the shaft does not rotate even when the external force is removed.

Even when the shaft 20 rotates in the reverse direction, the shaft may rotate through the free stop scheme until it reaches the first angle, and after the shaft 20 reaches the first angle through the reverse rotation, the shaft 20 may automatically rotate in the reverse direction by the elastic restoring force of the torsion spring 60.

In FIG. 8, in order to better understand the movement process of the clutch ball 45 according to the rotation of the shaft 20, the shaft 20 may be represented as moving linearly.

In the initial stop position in which the shaft 20 is not rotated, as shown in FIG. 8a, the clutch ball 45 may be inserted into the through hole 41 and the first seating groove 21.

In this case, the torsion spring 60 may generate a force to rotate the shaft 20 in the reverse direction.

Further, as shown in FIG. 11a, the blade 32 is disposed adjacent to the blocking member 31.

In this state, when the shaft 20 rotates forward (expressed as moving leftward in FIG. 8) by the external force, as shown in FIGS. 8(b) to (c), the clutch member 40 may move in the same direction as the shaft 20 by the clutch ball 45 inserted into the first seating groove 21 of the shaft 230.

In this case, the torsion spring 60 coupled to the clutch member 40 through the first support member 51 may be gradually compressed as the clutch member 40 rotates.

As the shaft 20 further rotates, as shown in FIG. 8(c), the shaft 20 may reach a section in which the first seating groove 21, the through hole 41, and the second seating groove 11 communicate with each other, that is, the first angle which is 75 degrees in the drawing of the present embodiment.

That is, when the shaft 20 rotates forward, the shaft 20 and the clutch member 40 may rotate together by the clutch ball 45 until they reach the first angle while compressing the torsion spring 60.

In this state, when the shaft 20 further rotates forward beyond 75 degrees, as shown in FIG. 8(d), the clutch ball 45 may be pushed by the movement of the shaft 20 so that the clutch ball 45 may come out of the first seating groove 21 and a part of the clutch ball 45 may move to the second mounting groove 11 across the through hole 41. As a part of the clutch ball 45 is inserted into the second seating groove 11, the clutch member 40 may be caught by the support end 19 of the housing 10 through the clutch ball 45 so that the clutch member 40 does not rotate anymore.

Therefore, as shown in FIGS. 8(e) and 8(f), the clutch ball 45 may completely come out of the first seating groove 21 and may be inserted into the through hole 41 and the second seating groove 11 as the shaft 20 rotates beyond the first angle. Thus, the rotational force of the shaft 20 may not be transferred to the clutch member 40 even when the shaft 20 rotates.

After that, even if the shaft 20 rotates to 180 degrees, the rotational force of the shaft 20 may not be transferred to the clutch member 40 and the clutch ball 45. Thus, only the shaft 20 may rotate without the rotation of the clutch member 40 and the clutch ball 45, and the rotation of the shaft 20 may not affect the torsion spring 60.

In this case, the reverse rotational power may act on the clutch member 40 by the torsion spring 60. Since the clutch member 40 is caught by the support end 19 of the housing 10 through the clutch ball 45, the clutch member 40 may remain at the first angle even if the reverse rotational force is applied thereto by the torsion spring 60.

As described above, when the shaft 20 rotates beyond the first angle corresponding to the second seating groove 11 formed in the support end 19, the shaft 20 may freely rotate in the forward and reverse directions through the free stop scheme without the elastic restoring force of the torsion spring 60.

In this process, as shown in FIGS. 11 and 12, the oil filled in the first inner chamber 16 may be pushed by the rotation of the shaft 20 and the blade 32 and flow through the first fluid path 15 and the third seating groove 23, thereby generating some damping force.

As shown in FIG. 11, when the shaft 20 rotates forward, the oil that flows while being pushed by the blade 32 may move through the third seating groove 23. In addition, when the blade 32 reaches the portion in which the first fluid path 15 is present, the oil may further move through the first fluid path 15, so that the shaft 20 may more easily rotate.

In addition, when reversely rotating the shaft 20 to the initial stop position by the external force in a state where the shaft 20 has rotated forward beyond the first angle, the operation of each component may be performed in the reverse order of FIG. 8.

That is, the clutch ball 45 seated in the through hole 41 and the second seating groove 11 may face the through hole 41 and the first seating groove 21 as the shaft 20 rotates in the reverse direction. Then, the clutch ball 45 may come out of the second seating groove 11 and move to the through hole 41 and the first seating groove 21.

From this point, the shaft 20 and the clutch member 40 are connected to each other by the clutch ball 45, so that the shaft 20 and the clutch member 40 may rotate together.

The clutch member 40 may be connected to the torsion spring 60. Since the elastic restoring force of the torsion spring 60 may be transferred to the clutch ball 45 and the shaft 20 through the clutch member 40, the shaft 20 may automatically rotate in the reverse direction.

Accordingly, the shaft 20 may return to the initial stop position by the elastic restoring force of the torsion spring 60.

Further, as the shaft 20 rotates in the reverse direction, as shown in FIG. 12, the oil filled in the first inner chamber 16 may be pushed by the rotation of the shaft 20 and the blade 32.

In this case, the blade 32 may come in close contact with the third-first seating groove 24 when the shaft 20 rotates in the reverse direction to block the communication between the third-first seating groove 24 and the third-second seating groove 25. Thus, the oil may be prevented from moving between the blade 32 and the third seating groove 23.

In addition, when the blade 32 comes in contact with the inner peripheral surface of the housing 10 at the portion where the first fluid path 15 is present, the oil may flow through the first fluid path 15, so that the shaft 20 may rotate in the reverse direction somewhat fast. Then, when the blade 32 reaches the portion in which the first fluid path 15 is absent, the shaft 20 may rotate slowly in the reverse direction.

As described above, the present invention may be applied to the door of the refrigerator door or the like in use.

In a state where the housing 10 is installed in the body object 82 (the refrigerator body) and the shaft 20 is connected to the rotating door, when the refrigerator door 81 is opened, the user forcibly rotates the shaft by applying the external force until the shaft 20 reaches the predetermined first angle. In addition, in the remaining angular positions beyond the first angle, the shaft may rotate through the free stop scheme, in which the shaft may not automatically rotate. When the refrigerator door 81 is closed, if the rotated shaft 20 reaches the predetermined first angle, the shaft and the refrigerator door 81 may be automatically rotated and closed by the elastic restoring force of the torsion spring 60.

As described above, according to the present invention, since the shaft 20 and the refrigerator door rotate through the free stop scheme in a section beyond the first angle, the refrigerator door may remain in an opened state even when the user does not hold the refrigerator door in the state beyond the first angle. Thus, the user may hold a heavy and large object by using two hands in a state where the refrigerator door is opened, or many objects may be easily put into or removed from the inside of the refrigerator. In addition, when it reaches the first angle through the reverse rotation, the refrigerator door can be automatically closed so that the convenience can be improved.

On the contrary, the shaft 20 may be connected to the body object 82, and the housing 10 may be mounted to the door 81. In this case, the housing 10 may rotate.

The hinge device for the rotating door of the present invention can be applied to a washing machine, a styler, a glass door, a room door, and the like, in which a door is rotatably installed, as well as the refrigerator.

The hinge device for the rotating door of the present invention is not limited to the above-described embodiment, and may be variously modified and implemented within the range in which the technical idea of the present invention is permitted.

What is claimed is:

1. A hinge device for a rotating door, the hinge device comprising:
a hollow housing provided therein with a support end having a hollow shape, in which a first inner chamber and a second inner chamber are formed at one side and an opposite side of the support end in communication with each other, respectively, and the first inner chamber is filled with oil;
a shaft disposed in the first inner chamber and rotatably mounted inside the housing, in which one end of the shaft is exposed to an outside through one end of the housing, an opposite end of the shaft is disposed in the first inner chamber, and an outer circumferential surface of the shaft is spaced apart from the first inner chamber such that oil is filled therebetween;
a damper unit installed in the first inner chamber to adjust an amount of flow of the oil filled in the first inner chamber during relative rotation of the housing and the shaft;
a clutch member disposed between the opposite end of the shaft and the support end;
a clutch ball mounted to one end of the clutch member to connect the clutch member to one of the support end and the shaft;
a first support member having one end fixedly coupled to the clutch member and an opposite end disposed in the second inner chamber, in which a first coupling protrusion protrudes from the opposite end of the first support member;
a second support member mounted to the opposite end of the housing and having a second coupling protrusion protruding toward an inside of the housing; and
a torsion spring installed in the second inner chamber and having one end coupled to the first coupling protrusion and an opposite end coupled to the second coupling protrusion,
wherein one end of the clutch member has a plate shape and is formed with a through hole into which the clutch ball is inserted to be movable in a longitudinal direction of the housing,
a first seating groove is formed in the opposite end of the shaft to face the through hole such that the clutch ball inserted into the through hole is seated in the first seating groove,
a second seating groove is formed at the support end to face the through hole such that the clutch ball inserted into the through hole is seated in the second seating groove,
the shaft and the clutch member are connected to each other when the clutch ball is inserted into both the through hole and the first seating groove so that a rotational force of the shaft is transferred to the clutch member through the clutch ball when the shaft rotates, thereby rotating the clutch member together with the shaft, and
the clutch member and the support end are connected to each other when the clutch ball is inserted into both the through hole and the second seating groove so that only the shaft independently rotates without rotation of the clutch ball and the clutch member when the shaft rotates.

2. The hinge device of claim 1, wherein the hinge device of the rotating door includes:
a compression section, in which the clutch member rotates together with the shaft from an initial stop position to a predetermined first angle to compress the torsion spring when the shaft rotates forward by an external force;
a free stop section in which the shaft rotates freely without compression or decompression of the torsion spring when the shaft rotates forward or backward in a state of exceeding the predetermined first angle; and
a recovery section in which the shaft automatically rotates in a reverse direction by an elastic restoring force of the torsion spring to return to the initial stop position when the shaft rotates reversely below the predetermined first angle in the free stop section.

3. The hinge device of claim 2, wherein the second seating groove is formed at a position corresponding to the predetermined first angle,
the clutch ball is inserted into the first seating groove and the through hole in the compression section and the recovery section so that the shaft, the clutch ball, and the clutch member rotate together, and
the clutch ball is inserted into the through hole and the second seating groove in the free stop section so that the shaft rotates independently from the clutch ball and the clutch member.

4. The hinge device of claim 3, wherein each of a depth of the first seating groove and a depth of the second seating groove is smaller than a radius of the clutch ball, so that a center point of the clutch ball is disposed in the through hole in a state where the clutch ball is inserted into the first seating groove and the through hole, and the center point of the clutch ball is disposed in the through hole in a state where the clutch ball is inserted into the second seating groove and the through hole.

5. The hinge device of claim 4, wherein, in a state where the clutch ball is inserted into the first seating groove and the through hole, when the shaft rotates forward beyond the predetermined first angle, the first seating groove, the through hole, and the second seating groove communicate with each other, and the clutch ball is pushed and moved by the rotation of the shaft so that the clutch ball comes out of the first seating groove and is inserted into the through hole and the second seating groove, and
in a state where the clutch ball is inserted into the second seating groove and the through hole, when the shaft reversely rotates beyond the predetermined first angle, the first seating groove, the through hole, and the second seating groove communicate with each other, and the clutch ball is pushed by the rotation of the clutch member caused by the elastic restoring force of the torsion spring so that the clutch ball comes out of the first seating groove and is inserted into the through hole and the second seating groove.

6. The hinge device of claim 3, wherein a reverse rotational force caused by the elastic restoring force of the torsion spring is applied to the shaft in the initial stop position.

7. The hinge device of claim 6, wherein the first seating grooves are formed at intervals of 120 degrees, the clutch ball includes three clutch balls, the second seating grooves are formed at intervals of 120 degrees, and the predetermined first angle is less than 90 degrees at the initial stop position.

8. The hinge device of claim 1, wherein the housing includes:
a first housing formed therein with the first inner chamber where the shaft is disposed, and provided at an opposite end thereof with the support end; and
a second housing having one end coupled to the opposite end of the first housing and an opposite end on which the second support member is mounted, and formed therein with the second inner chamber where the torsion spring is disposed, and
the opposite end of the clutch member is fixedly coupled to the first support member through the support end.

9. The hinge device of claim 8, further comprising a bearing surrounding the first support member, wherein one end of the bearing is disposed between an inner peripheral surface of one end of the second housing and the first support member so that the bearing is rotatable and linear movement of the bearing is prevented.

10. The hinge device of claim 1, further comprising:
a height adjusting nut screwed to one end of the housing;
a height adjusting ring having one end exposed to an outside of one end of the height adjusting nut and one end of the housing, and an opposite end inserted between the height adjusting nut and the housing; and
a snap ring configured to couple the height adjusting nut and the height adjusting ring to move the height adjusting nut and the height adjusting ring together in a longitudinal direction of the housing,
wherein, when the height adjusting nut rotates relative to the housing, the height adjusting ring coupled to the height adjusting nut through the snap ring moves in the longitudinal direction of the housing to adjust a distance with respect to one end of the housing.

11. The hinge device of claim 1, wherein the damper unit includes:
a blocking member having one end fixedly coupled to an inner peripheral surface of the first inner chamber and an opposite end making contact with an outer circumferential surface of the shaft; and
a blade disposed between the shaft and the inner peripheral surface of the first inner chamber,
wherein, when the shaft rotates, the blocking member is fixed together with the housing and the blade moves together with the shaft while making contact with the inner peripheral surface of the first inner chamber, and the blade changes an amount of movement of the oil filled in the first inner chamber.

12. The hinge device of claim 11, wherein a first fluid path is concavely formed at the inner peripheral surface of the first inner chamber in a circumferential direction of the housing,
the blade is disposed in a longitudinal direction of the shaft,
when the shaft rotates, the blade moves through a portion where the first fluid path is absent and a portion where the first fluid path is present in contact with the inner peripheral surface of the first inner chamber,
the oil moves through the first fluid path when the blade is disposed in the portion where the first fluid path is present, and
the shaft rotates more slowly when the blade is disposed in the portion where the first fluid path is absent than the blade is disposed in the portion where the first fluid path is present.

13. The hinge device of claim 12, wherein a third seating groove where the blade is seated is formed on the outer circumferential surface of the shaft,
the blade is spaced apart from the third seating groove and the oil moves therebetween when the shaft rotates forward, and
the blade comes in close contact with the third seating groove to block movement of the oil between the blade and the third seating groove when the shaft reversely rotates.

14. The hinge device of claim 13, wherein the third seating groove includes:
a third-first seating groove having an arc shape; and
a third-second seating groove formed by chamfering the shaft from the third-first seating groove in the circumferential direction of the shaft such that the third-second seating groove has a depth greater than a depth of the third-first seating groove, and
the blade is provided with a seating protrusion seated in the third-first seating groove,
the seating protrusion is smaller than the third-first seating groove and movably disposed in the third-first seating groove,
when the shaft rotates forward, the seating protrusion is pushed toward the third-second seating groove by the oil and allows the third-first seating groove to communicate with the third-second seating groove so that the blade is spaced apart from the third seating groove and the oil moves therebetween, and
when the shaft reversely rotates, the seating protrusion is pushed opposite to the third-second seating groove by the oil and comes in close contact with the third-first seating groove to prevent the oil from moving between the blade and the third seating groove.

15. The hinge device of claim 14, wherein the shaft is formed at a center thereof with a bolt insertion hole,
an oil adjusting bolt is installed in a bolt insertion hole,
a bypass passage is formed in the shaft to allow the bolt insertion hole to communicate with the outer circumferential surface of the shaft, and
a size of communication between the bypass passage and the bolt insertion hole is variable by the oil adjusting bolt so that an amount of movement of the oil through the bypass passage is controlled.
